(19) United States
(12) Patent Application Publication
(10) Pub. No.: US 2018/0040266 A1
(43) Pub. Date: Feb. 8, 2018

(54) CALIBRATED COMPUTER DISPLAY SYSTEM WITH INDICATOR

(71) Applicant: Keith Taylor, Apple Valley, CA (US)

(72) Inventor: Keith Taylor, Apple Valley, CA (US)

(21) Appl. No.: 15/671,710

(22) Filed: Aug. 8, 2017

Related U.S. Application Data
(60) Provisional application No. 62/372,016, filed on Aug. 8, 2016.

(51) Int. Cl. G09G 3/00; G06K 9/78; G06K 9/00

(52) U.S. Cl. CPC G09G 3/001; G06K 9/00664; G06K 9/78; G06K 2209/03

(57) ABSTRACT

A calibrated computer display system 10 including an indicator 60 for indicating a position 61 on the computer display 40 and a monitoring device 50 is claimed. The system relates the indicated position 61 on the display 40, as detected in the monitoring device 50, to a position expressed in terms of the coordinates of the computer display 40. The system 10 relates the indicated position captured by the monitor 61 to the coordinates of the computer display 40 using calibration parameters determined from the position of the corners of the computer display as designated in the monitoring device 50 and the lengths of a plurality of sides of the display as indicated in the monitoring device 50.

### CROSS-REFERENCE TO RELATED APPLICATIONS

This present application claims benefit under 35 U.S.C. § 119(e) to U.S. Provisional Application Ser. No. 62/372,016, filed on 8 Aug. 2016, the contents of which are incorporated herein by reference in their entirety.

### BACKGROUND OF THE INVENTION

The present invention relates to an apparatus for, and method for calibrating, a computer display system incorporating an interactive point designator. A point designator, such as projected laser beam from a laser pointer or other predetermined, computer-recognizable, target is used to identify points on a computer display, including, for example, a projected display, or a large monitor, or array of monitors use as a single display. The computer system is calibrated to quickly and efficiently recognize the location of the designated point upon the display and to interactively react accordingly, including, if appropriate, by updating the display contents.

### SUMMARY OF THE INVENTION

The present invention, in at least one embodiment, relates to a system for using an interactive pointing device with a computer display or projected computer display. Such systems operate by projecting or presenting on a large display device, the graphical display from a computer. A monitoring device, such as one or more cameras or a separate processor with attached camera is focused on the display and displays both the display contents and recognizes an external pointing indicator.

The indicator may be anything which the monitoring device can detect and which is understood by the computer device to indicate a desired point on the display. Typically, the indication created by the indicator will be the bright point of light from a laser pointer on the display, but it is readily understood that other indications, such as the end of a physical pointer, a finger tip, a focusable flashlight beam, or the tip of a glove could be used, so long as the indication can be recognized as such by a computing device processing data from the monitoring device.

The types of applications for which the present invention is useful ranges through several industries including, but not limited to gaming, health care, law enforcement, light or color intensity related science or engineering measurements, training and education, and multimedia presentations.

The gaming industry could utilize the present invention whenever a laser or other light source outside of the game environment would change characteristics of the display as captured by the monitoring device. This change could indicate that a target, or game object had been hit. Although there may be built-in ways to check if an object within the game has moved into a certain area of the camera view, this may not be the best way to check for such movement and the present system allows for external validation that some object within the game had moved into that position as well.

The health-care industry can use the system for similar things as the gaming industry. The difference being that instead of hitting game objects for points or high scores, the system could gather data for the diagnosis and measurements of movements as it would pertain to a light source that is connected to a head-set, hand held device, or other apparatus that would measure movement or on again, off again light or color data. Clinicians can also utilize the system to teach hand and eye coordinated tasks using multiple target vectors.

Unlimited training scenes could be built within houses, neighborhoods, or a myriad of other scenarios that would allow law enforcement and military personnel to train for situations that would be more cost effective and safer while using non-projectile weaponry and trigger activated light devices. The ability to have interactive targets within the training scenarios could be built into the environment using game engine software to project the scenes and a plug-in module or remote processor to check for target hits or misses.

Science and engineering technicians and students would be able to use the present invention along with other algorithms to measure changes in light intensity or color in a given area of the target area.

Educators could utilize the present invention to test and teach coordinated tasks like tracking, for color, letter, number and object recognition as well as hand and eye coordination training. The hand within a target pixel would change the pixel color value so children would not be subject to laser light. Flashlight type devices could also be used.

Multimedia applications could use a plugin module to allow for changing slides with a laser pointer or even a change in the pixel color, such as a hand or stick type pointer going into the target area and changing the RGB value of the pixel.

Each time the relative geometry of physical relationship between the display and the monitoring device changes, even from just bumping or jostling a part of the equipment or table, the system must be re-calibrated. Except for fixed venues with dedicated immobile equipment, this means that frequent recalibration of the equipment may be required. Consequently, systems which require complicated or computationally complex calibration methodologies present a serious practical obstacle to such systems.

A key prerequisite for the practical operation of such a system, in particular, a system which is intended to be portable, is an efficient and straight-forward calibration system, which does not, for example, require the manipulation of calibration matrices or the general solution of simultaneous multi-dimensional linear equations.

The present invention uses a straight-forward system to relate positions in the field of view of the monitoring device to corresponding positions on the display or projected display. Ideally, this relationship would be simplest if the central line-of-sight of the monitoring device passed directly through the center of the display, perpendicularly to the display surface, and the field-of-view of the monitoring device were of the same shape, size, and resolution as the display. In reality, this scenario is unlikely to occur and is nearly impossible for a projected display, because the monitoring device would need to be in the same physical location as the projector.

To relate a position in the display to a position from the monitoring device adjustments must be made for the vertical inclination of the monitoring device's field-of-view relative to the display, for the horizontal inclination of the monitoring device's field-of-view relative to the display device, and the offset between the central line of sight of the monitoring device and the center of the display, as well as the results of the interactions of these parameters.

### BRIEF DESCRIPTION OF THE DRAWINGS

The features, aspects and advantages of the present invention will become better understood with regard to the following description, appended claims and accompanying figures wherein:

FIG. 1 is an illustration of an embodiment of a projected computer display and camera type monitoring device according to the present invention.

FIG. 2A is a flow chart illustrating the steps involved in using the computer display, camera type monitoring device, and point designation indicator in accord with an embodiment of the present invention.

FIG. 2B is a flow chart illustrating the steps involved in using the computer display, processing type monitoring device, and point designation indicator in accord with an embodiment of the present invention.

FIG. 3 is a flow chart illustrating the steps of calibrating the display and monitoring device in accordance with an embodiment of the present invention.

FIG. 4 is a functional illustration of a computer including contents of the computer display in accordance with an embodiment of the present invention showing the monitoring device view of the computer display.

FIG. 5A is a functional illustration of the contents of a computer display showing the monitoring device view of the display and the corner identification and central point calibration interface.

FIG. 5B is a schematic illustration of the geometry of the monitoring device view of the display and calibration interface.

FIG. 6A is a functional illustration of a computer showing the monitoring device view of the display prior to alignment of the central line-of-sight of the monitoring device with the display.

FIG. 6B is a functional illustration of a computer showing the monitoring device view of the results the alignment of the central line-of-sight of the monitoring device with the display, in an embodiment of the device.

FIG. 7A is a functional illustration of a computer with a screen illustrating the proportional coordinates of a designated point on a computer screen.

FIG. 7B is a schematic illustration of the placement of the designated point on the display based on proportional location of the designated point on computer's screen.

FIG. 8 is an illustration of an embodiment of a projected computer display with a mobile phone operating as a processing type monitoring device according to the present invention.

### DETAILED DESCRIPTION

In the following description of the preferred embodiments, reference is made to the accompanying drawings which show by way of illustration specific embodiments in which the invention may be practiced. Wherever possible, the same reference numbers will be used throughout the drawings to refer to the same or like parts. It is to be understood that other embodiments may be utilized and structural and functional changes may be made without departing from the scope of the present invention.

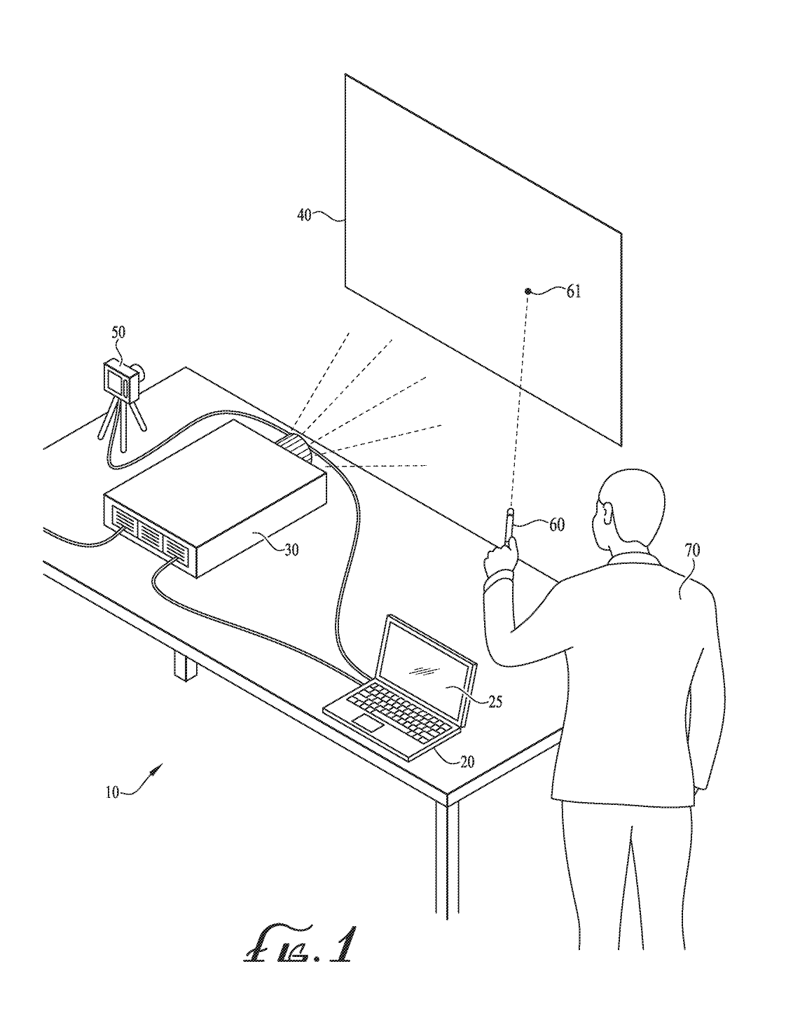

FIG. 1 illustrates an embodiment of the overall display and calibration system 10. A computer 20 is connected to a projector 30 which projects the contents of the computer's screen 25 onto a large display 40. The contents of the display 40 are monitored by a monitoring device 50, which is in this embodiment a small tripod mounted camera. The output of the monitoring device 50 is fed to the computer 20 and can be displayed simultaneously with the contents of the computer screen 25 to create a calibration that allows for association of positions on the display 40 as viewed by the monitoring device 50 with positions on the computer's screen 25. In operation, a laser pointer 60 may be used by an operator 70 to indicate locations 61 upon the display 40 in such a way that the locations are picked up by the monitoring device 50. It would be appreciated by a person of ordinary skill in the art that many alternatives to the use of the laser pointer 60 to indicate locations on the display are available, including use of the end of physical pointer, a fingertip, or the tip of a glove. The only requirement is that the indication can be recognized as such by a computer 20 processing data from the monitoring device 50.

FIG. 8 illustrates an embodiment of the overall display and calibration system 10. A computer 20 is connected to a projector 30 which projects the contents of the computer's screen 25 onto a large display 40. The contents of the display 40 are monitored by a processing monitoring device 55. The processing monitoring device 55 includes a camera, processing functionality, and processing logic sufficient to determine the association of positions on the display 40 as viewed by the processing monitoring device 55 with positions on the computer's screen 25. In operation, a laser pointer 60 may be used by an operator 70 to indicate locations 61 upon the display 40 in such a way that the locations are picked up by the processing monitoring device 55. The position of a location 61 indicated by a point of light from the laser pointer 60 on the large display 40 referenced in terms of the computer's screen 25 is communicated, to the computer 20. It would be appreciated by a person of ordinary skill in the art that many alternatives to the use of the laser pointer 60 to indicate locations on the display are available, including use of the end of physical pointer, a fingertip, or the tip of a glove. The only requirement is that the indication can be recognized as such by the processing monitoring device 55. Similarly, the communication between the processing type processing monitoring device 55 and the computer 20 may be achieved through wireless communications protocols such as Bluetooth or Wi-Fi, through a wired connection using a USB protocol, or through a proprietary wired or wireless communication protocol. The processing monitoring device may constitute a smart phone or other such handheld device having a camera and equipped with the appropriate logic or may comprise a special built device with built-in camera functionality, or which connects to a separate camera.

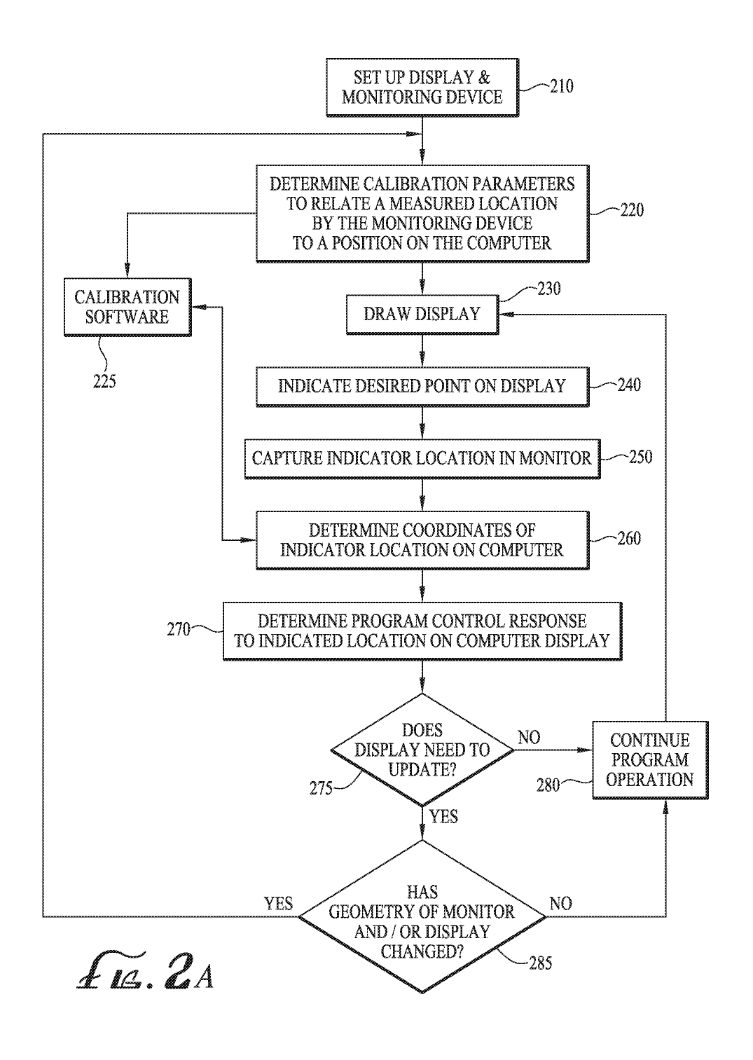

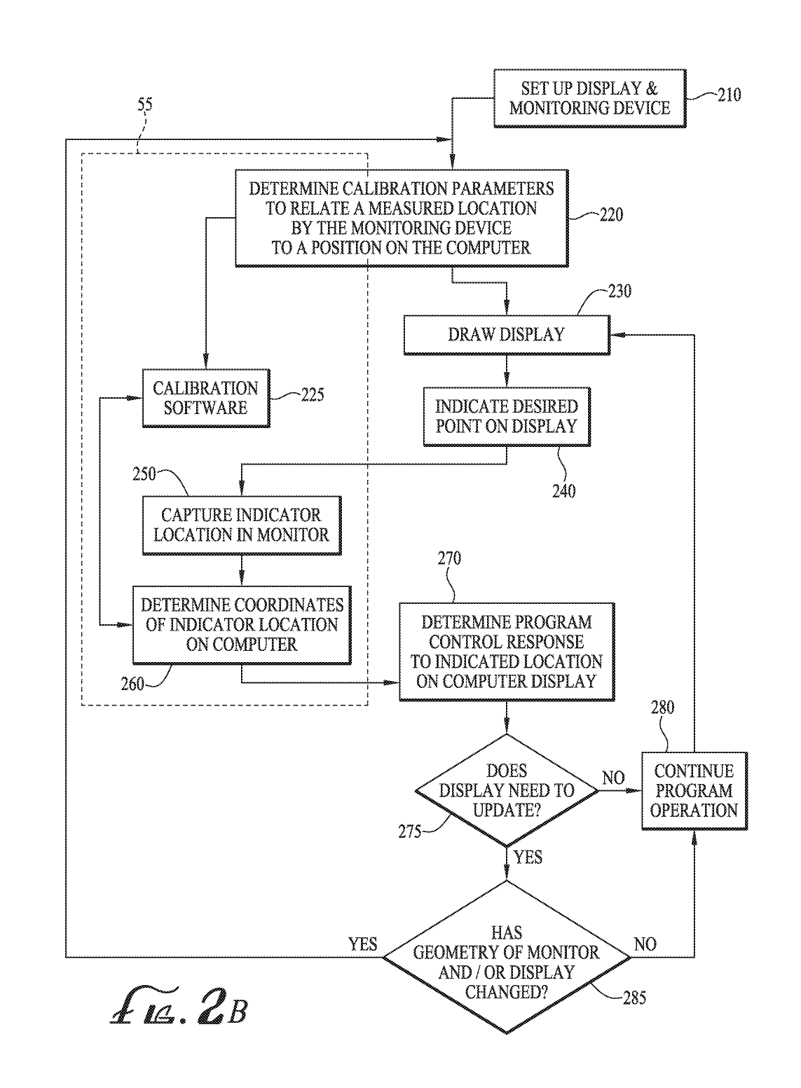

FIG. 2A illustrates a flowchart for one embodiment of a method of operating the system in which the processing of an indicated location is performed within the computer 20. The initial step 210 is to physically set up the display 40 and monitoring device 50, establishing the geometry between them. Once the geometry between the display 40 and the monitoring device 50 is established, the next step 220 is to determine calibration parameters which will allow a location detected by the monitoring device and known in the coordinates of the monitoring device to be related via calibration software 225 that uses the calibration parameters to determine the corresponding indicated position on the computer screen 25 and display 40 in the coordinates of the computer screen and display.

Once calibrated in a manner discussed below, the contents of the computer screen 25 and display 50 are drawn 230 in accord with a program running on the computer 20 and controlling the computer screen 25 and display 40. It would be readily apparent to a person of ordinary skill that the control of the computer screen 25 and the display 40, might ultimately result from a program running remotely and communicating with the computer 20.

A desired point may then be indicated 240 on the display 40. This point may be created by use of a laser pointer shining a bright dot upon a point on the display, or it can be achieved by use of a physical pointer, a fingertip, or a predefined glove. Regardless of how the point is indicated upon the display, it must be recognized and its location captured 250 by the computer 20 in the output from the monitoring device 50. This may be achieved by identifying a bright spot, a spot of known color, or a pre-defined shape. Methods for detecting the presence and location of such an indicated point in the output from the monitoring device 50 would be readily known to a person of skill in the art, including brightness, color, and/or pattern matching. The location of the indicated point on the display 40 and detected in the output from the monitoring device 50 is determined and related to coordinates of the indicated location on the computer screen 25. The step 260 involves determining the location of the indicated point in terms of the monitoring device output coordinates and using the previously determined calibration values in calibration software 225 to relate it to locations relevant to the computer screen 25.

Once the coordinates of the location of the indicated point, in terms of the computer display, are determined 260 using the calibration software 225, control is ceded in step 270 to the controlling program, which may be running on the computer 20 or running on a separate computing device and communicating with the computer 20. The program must determine whether the controlling program wishes to change the content of the computer's screen 25 and the display 40. If an update to the contents of the computer's screen 25 and the display 40 is not needed, then the program control loops back to continue operation in steps 280 and 270. If the content of the computer's screen 25 and the display 40 must be updated, it is necessary to determine, in step 285, if the relative geometry between the monitoring device 50 and the display 40 has changed, although for efficient operation, this should happen infrequently. It would be obvious to one of ordinary skill in the art, that in typical operation, in alternative embodiments it could be assumed that the geometry does not change and recalibration would only be initiated upon manual intervention by an operator. If the geometry has not changed, or has been assumed to not change, then the process will loop back to step 230 and the computer's screen 25 and the display 40 would be re-drawn. If the relative geometries have changed, then it will be necessary to transfer control back to the process of determining the calibrations 220.

FIG. 2B illustrates a flowchart for an alternative embodiment of a method of operating the system in which the processing of an indicated location is performed with the assistance of a monitoring device which also performs some processing of the indicated location. An embodiment using an external processing monitoring device will allow for smoother video from the computer and a faster response, as the CPU of the computer 20 is not performing all of the calculations of every step. The initial step 210 is to physically set up the display 40 and processing monitoring device 55, establishing the geometry between them. Once the geometry between the display 40 and the processing monitoring device 55 is established, the next step 220 is to determine a calibration which will allow a location detected by the processing monitoring device 55 and known in the coordinates of the processing monitoring device 55 to be related to the corresponding location on the computer screen 25. In an embodiment using a processing monitoring device, the determination of the calibration parameters involves both the computer 20 and the processing monitoring device 55. The processing monitoring device 55 may be a camera augmented with functionality to allow it to process the image, recognize the indicated point 61 on the display 40, process the indicated location using the calibration parameters, and communicate the indicated location, converted to the coordinates of the computer screen 25, to the computer 20. In at least one embodiment, the processing monitoring device 55 may be a camera equipped smartphone with special purpose software to interoperate with the computer 25.

Once calibrated in a manner discussed below, the contents of the computer screen 25 and display 50 are drawn 230 in accord with a program running on the computer 20 and controlling the computer screen 25 and display 40. It would readily apparent to a person of ordinary skill that the control of the computer screen 25 and the display 40, might ultimately result from a program running remotely and communicating with the computer 20.

A desired point may then be indicated 240 on the display 40. This may be achieved by use of a laser pointer shining a bright dot upon a point on the display, or it can be achieved by use of a physical pointer, a fingertip, or a predefined glove. Regardless of how the point is indicated upon the display, it must be recognized by the processing monitoring device 55. This may be achieved by identifying a bright spot, a spot of known color, or a by a pre-defined shape. Methods for detecting the presence and capturing the location 250 of such an indicator in the output from the processing monitoring device 55 would be readily known to a person of skill in the art, including brightness, color, and/or pattern matching. The location of the indicator on the display 40 and detected in by the processing monitoring device 55 is determined and related to coordinates of the indicated location on the computer screen 25. The step 260 involves determining the location of the indicator in terms of the processing monitoring device output coordinates and using the previously determined calibration parameters in the calibration software 225 operating in the processing monitoring device 55 to relate it to locations relevant to the computer screen 25.

Once the coordinates of the location of the indicated point in terms of the computer display are known, control is ceded in step 270 to the controlling program, which may be running on the computer 20 or running on a separate computing device and communicating with the computer 20. The program must determine whether the controlling program wishes to change the content of the computer's screen 25 and the display 40. If an update to the contents of the computer's screen 25 and the display 40 is not needed, then the program control loops back to continue operation in steps 280 and 270. If the content of the computer's screen 25 and the display 40 must be updated, it is necessary to determine, in step 285, if the relative geometry between the monitoring device 50 and the display 40 has changed, although for efficient operation, this should happen infrequently. It would be obvious to one of ordinary skill in the art, that in typical operation, in alternative embodiments it could be assumed that the geometry does not change and recalibration would only be initiated upon manual intervention by an operator. If the geometry has not changed, or has been assumed to not change, then the process will loop back to step 230 and the computer's screen 25 and the display 40 would be re-drawn. If the relative geometries have changed, then it will be necessary to transfer control back to the process of determining the calibrations 220.

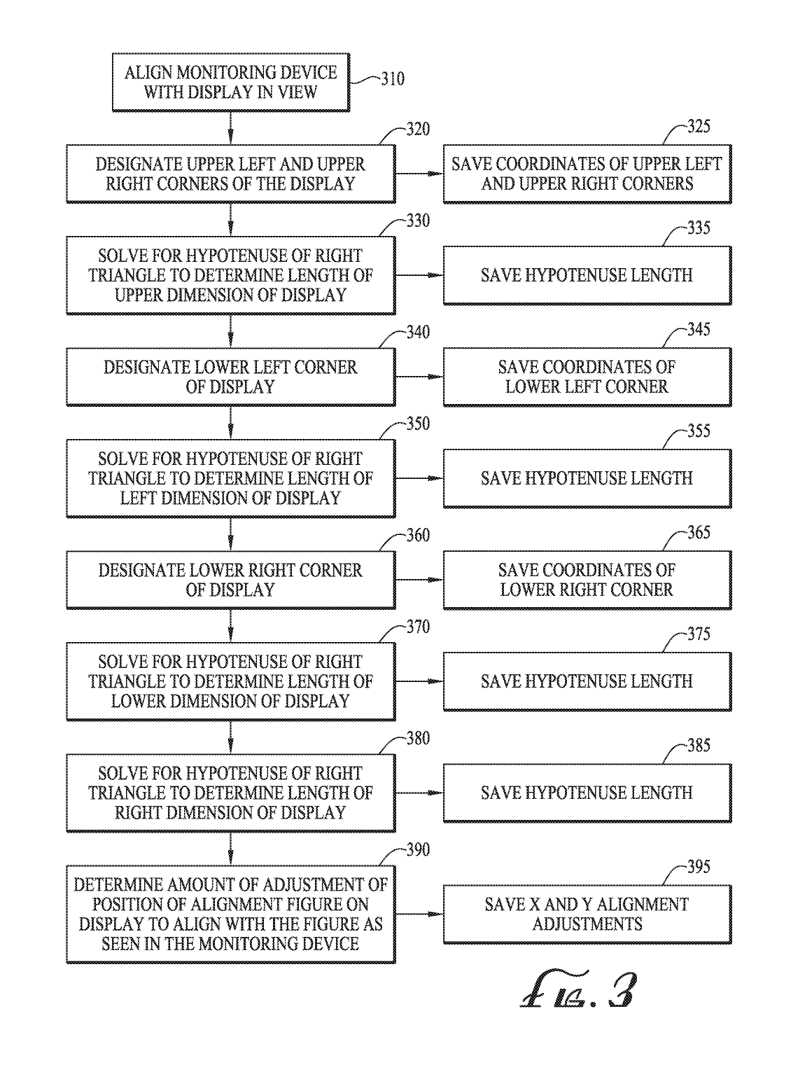

FIG. 4 provides a schematic illustration of a computer 410 comprising a computer screen 430 and a keyboard/display controller 420 as it is being used to determine the calibration parameters. The computer screen 430 displays the output from the monitoring device 50 as well as a calibration portal 470. The original contents 440 of the computer's screen 25 that have been projected upon the display 40 are shown as well as the image of the alignment portal 460 as it is viewed on the display 40 by the monitoring device 50 or the processing monitoring device 55. The contents of the original display on the computer's screen are located within a parallelogram 450 on the computer screen 430.

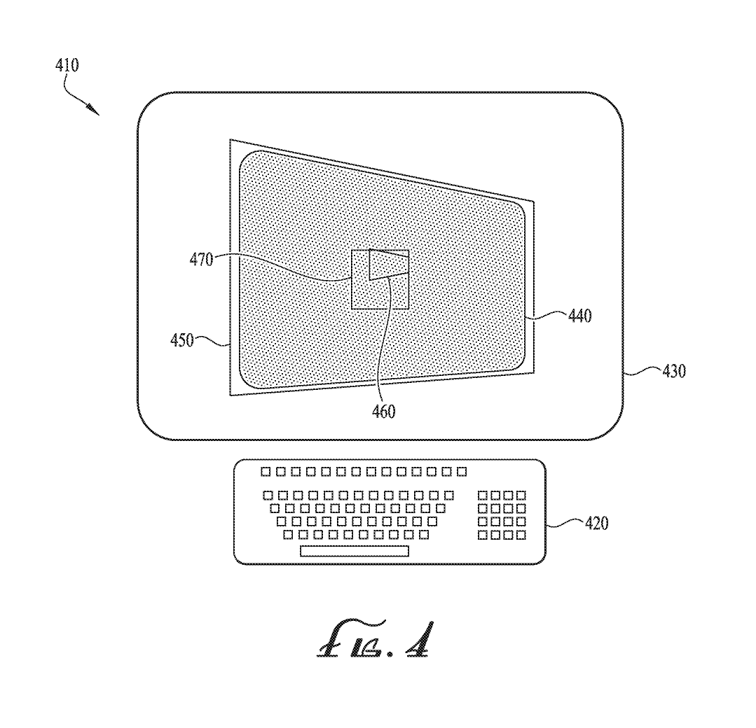

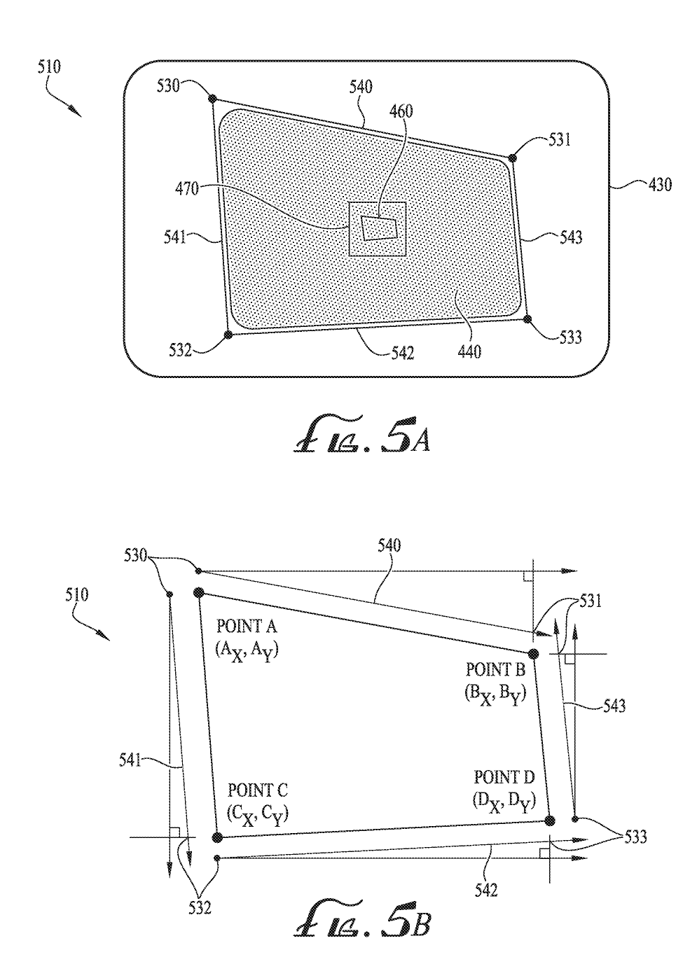

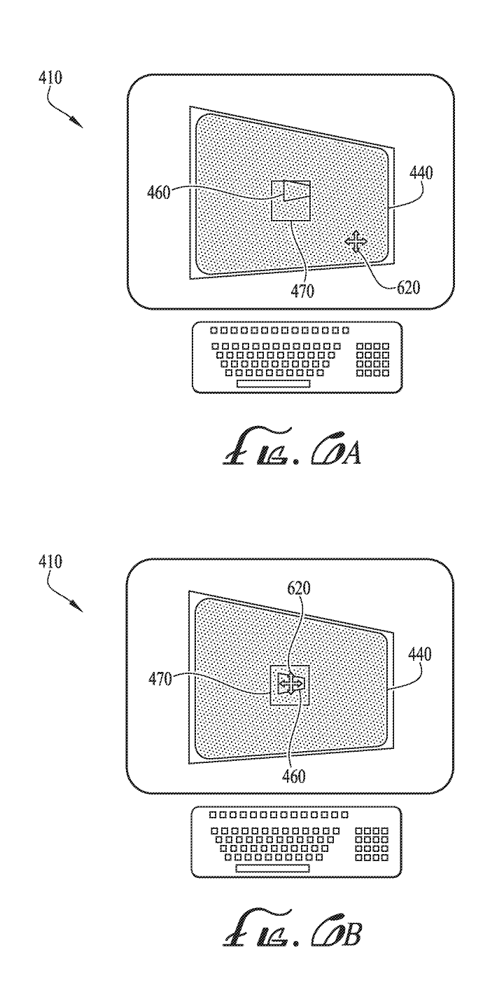

FIG. 5A schematically illustrates the contents of the computer screen and FIG. 5B illustrates the relative geometries between key points on the screen. The process of determining the values allowing for calibration between the coordinates on the original computer screen 25 and those for the display 40 as seen through the monitoring device 50 is illustrated in FIG. 3 and may best be understood by discussion with reference to FIGS. 5A, 5B, 6A, and 6B.

The initial step 310 of the calibration process is to align the monitoring device 50 or the processing monitoring device 55 such that the display 40 is in full view. The contents of the original computer screen will now be seen through the output from the monitoring device 50 or processing monitoring device 55 projected as a parallelogram 440. Throughout this description the term designate will be used to mean to use the computer controls, typically a mouse and linked display cursor, to identify to the computer where a point on the display is located. This is typically performed by using the mouse to click on and drag a cursor or other visual indicator to a desired spot on the screen and then releasing the mouse to indicate the location, although it would be apparent to one of ordinary skill in the art that other user interface methods could be employed. Alternative methods could include automated identification of reference locations, including locations based upon defined display geometry. The upper left 530 and upper right 531 corners of the parallelogram projection 440 of the computer display are designated in step 320 of the calibration process. The coordinates of these points represented in the coordinate frame of the monitoring device 50 or processing monitoring device 55 are recorded in step 325. The length of the hypotenuse 540 of the right triangle formed by the upper left 530 and upper right 531 corners is calculated in step 330 and recorded in step 335. It should be noted that throughout when the term “right triangle” is used this means a “right triangle” in the coordinate frame of the computer screen 430 and not in the coordinate frame of the projected screen 440.

The coordinates of the lower left corner 532 of the parallelogram projection of the computer screen display 25 is designated (step 340) and saved (step 345). The length of the hypotenuse 541 of the right triangle formed by the upper left 530 and lower left 532 corners is determined (step 350) and saved (step 352).

The coordinates of the lower right corner 533 of the parallelogram projection of the computer screen display 25 is designated (step 360) and saved (step 365). The length of the hypotenuse 542 of the right triangle formed by the lower left 532 and lower right 533 corners is determined (step 370) and saved (step 375). The length of the hypotenuse 543 of the right triangle formed by the lower right 534 and upper right 531 corners is determined (step 380) and saved (step 385).

Although the reference points in the above described embodiment are at or near the corner of the display as depicted in the monitoring device, it would be clear to one of ordinary skill in the art, that reference points located elsewhere could be used or when coupled with additional information fewer points may be used so long as the information and point locations are sufficient to define the relationship between the computer display and its appearance in the monitoring device.

FIG. 6A illustrates a schematic of the computer 410 while performing calibration. The parallelogram projection 440 of the computer display is shown as well as an alignment portal 470 and the projection 460 of the alignment portal as seen by the monitoring device 50 or processing monitoring device 55. As shown in FIG. 6A, the portal 470 and its projection 460 are not centered. Using a cursor 620 the location of the portal 470 is aligned so that it and its projection 460 as seen by the monitoring device 50 or processing monitoring device 55 are centered as shown in FIG. 6B. The amount of adjustment (Δx, Δy) necessary to effect this change is tracked (step 390) and saved (step 395).

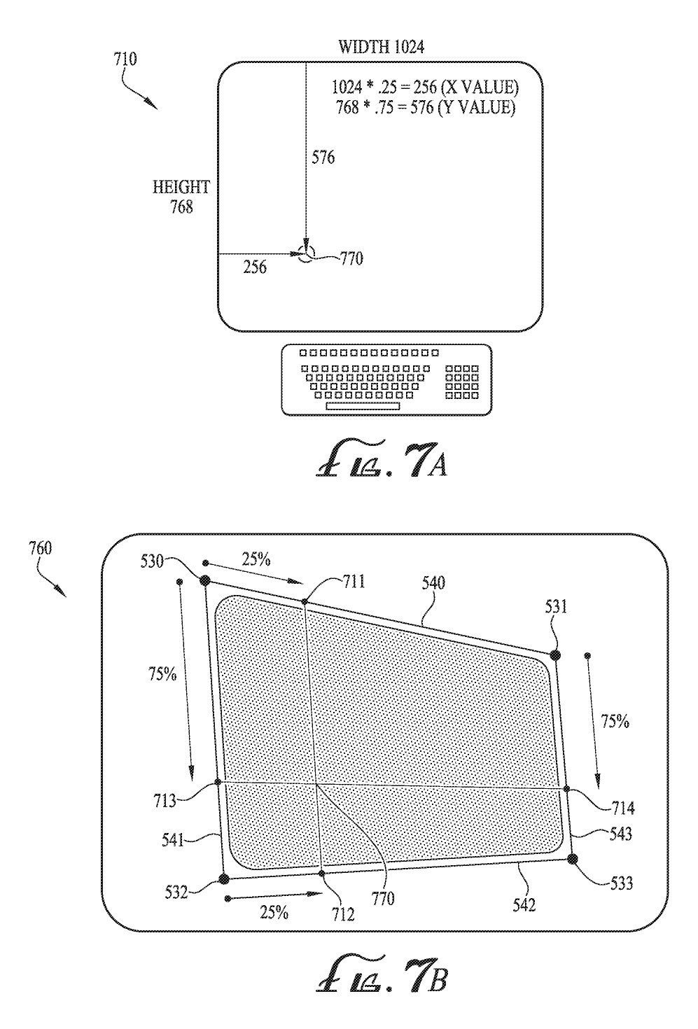

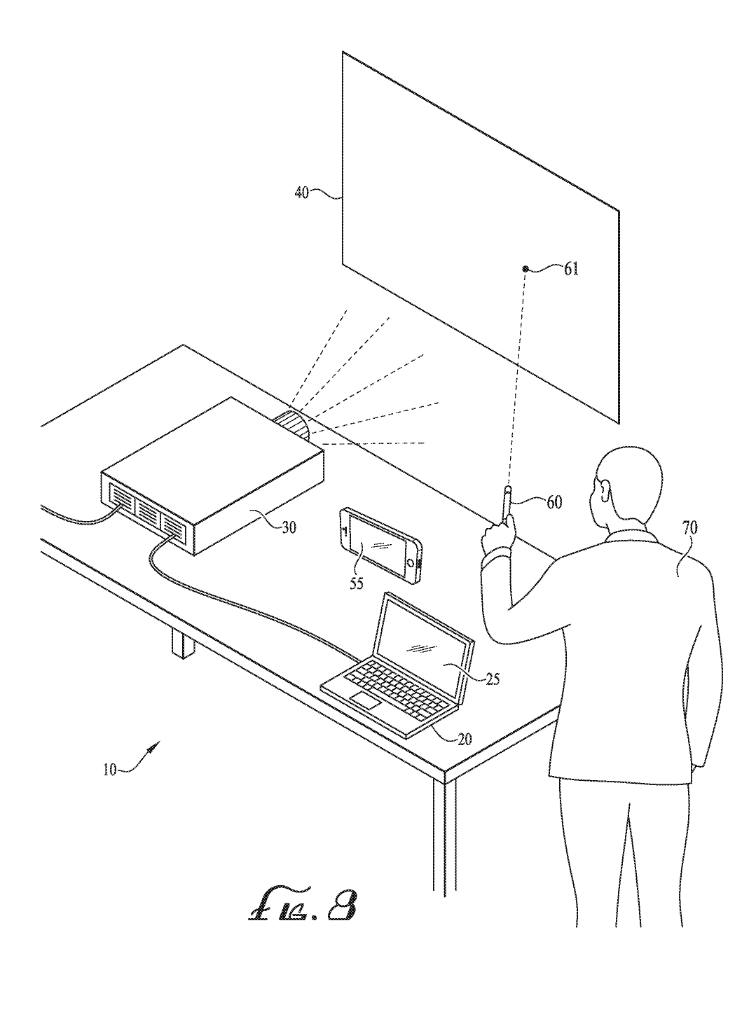

When comparing the location of an indicated spot as seen in the output of the monitoring device with that on the computer screen it is necessary to determine where a location on the computer screen is expected to appear in the output of the monitoring device. This is readily achieved in the present invention through the use of the calibration parameters saved as illustrated in FIG. 3. FIG. 7A illustrates the location of a point 770 at the (x,y) pixel coordinates of (256,756) on a computer's screen 710. Given that this is on a screen having known dimensions of 1024×768, the proportional (x%,y%) location of the spot is (25%,75%). The location of this point 770 in the projected display 760 as seen in the output of the monitoring device 50 is shown in FIG. 7B. Given the coordinates of the corners 531, 532, 533, 534 of the parallelogram projection of the computer's screen 440 and the lengths 540, 541, 542, 543 of the sides of the parallelogram projection 440, the use of the same trigonometric relationships that allowed for the calculation of the lengths of the sides to determine the coordinates (X′,Y′) of the desired point 770. For example, the coordinates of the endpoints 711 and 712 or 713 and 714 are readily calculated from the corresponding side lengths and coordinates of the endpoints and the coordinates of the desired point 770, readily calculated by the proportional position on the line between the endpoints.

After determining the coordinates of the desired position in the parallelogram projection 140 of the computer screen, the values must be adjusted to account for an offset between the center of the parallelogram projection 140 and the center of the field of view of the monitoring device 50 to determine the ultimate coordinates (X, Y). This adjustment is performed using the percentage of the target distance across the width and the height of the projection as it relates to the coordinates saved in the calibration software.

Although the preceding example was stated in terms of converting from coordinates in the coordinates of the computer's screen (x,y) to those in terms of the output of the monitoring device (X,Y), the inverse conversion is readily performed by executing the process in the inverse manner.

There is disclosed in the above description and the drawings, an operating room viewing system that fully and effectively overcomes the disadvantages associated with the prior art. However, it will be apparent that variations and modifications of the disclosed embodiments may be made without departing from the principles of the invention. The presentation of the preferred embodiments herein is offered by way of example only and not limitation, with a true scope and spirit of the invention being indicated by the following claims.

What is claimed is:

1. An interactive computer display system comprising:
a computer;
a display device displaying visual content from the computer;
a monitoring device wherein the monitoring device produces a plurality of images of the visual content of the display;
wherein the plurality of images of the visual content of the display are communicated to the computer;
wherein the computer includes logic to allow the coordinates of a position in one or more of the plurality of images produced by the monitoring device to be related to coordinates of the corresponding position in the display;
wherein the logic derives calibration parameters from the coordinates of one or more reference points on the display in one or more of the plurality of images of the visual content of the display and the distances between the reference points on the display as depicted in the one or more of the plurality of images of the visual content of the display.

2. The interactive computer display system of claim 1, further comprising:
an indicator;
wherein a position of the indicator in one or more of the plurality of images produced by the monitoring device is determined by the computer; and
wherein the computer determines the corresponding position of the indicator in the display of the computer using the calibration parameters.

3. The interactive computer display system of claim 1, wherein the one or more reference points on the display are at or near the corners of the display as depicted in the one or more of the plurality of images of the visual content of the display.

4. The interactive computer display system of claim 2 wherein the indicator is a point of light projected onto the display from a light emitting device.

5. The interactive computer display system of claim 4, wherein the light emitting device is a laser.

6. The interactive computer display system of claim 4, wherein the light emitting device is a flashlight.

7. The interactive computer display system of claim 2, wherein the indicator is a physical pointer.

8. The interactive computer display system of claim 2, wherein the indicator is a fingertip.

9. An interactive computer display system comprising:
a computer;
a display device displaying visual content from the computer;
an indicator;
a monitoring device, wherein the monitoring device produces a plurality of images of the visual content of the display;
wherein the monitoring device processes one or more of the plurality of images of the visual content of the display to determine a position of the indicator in the one or more of the plurality of images produced by the monitoring device;
logic to allow the coordinates of the position, in one or more of the plurality of images produced by the monitoring device, to be related to coordinates of the corresponding position in the display;
wherein the monitoring device determines the corresponding position of the indicator in the display of the computer; and
wherein the corresponding position of the indicator in the display of the computer is communicated by the monitoring device to the computer.

10. The interactive computer display system of claim 9 wherein the monitoring device uses calibration parameters to determine the corresponding position of the indicator in the display of the computer; and
the calibration parameters are derived from the locations of a plurality of reference points on the display as depicted in one or more of the plurality of images of the visual content of the display.

11. The interactive computer display system of claim 10, wherein one or more of the plurality of reference points on the display are at or near the corners of the display as depicted in the one or more of the plurality of images of the visual content of the display.

12. The interactive computer display system of claim 10, wherein the indicator is a point of light projected onto the display from a light emitting device.

13. The interactive computer display system of claim 12, wherein the light emitting device is a laser.

14. The interactive computer display system of claim 13, wherein the light emitting device is a flashlight.

15. The interactive computer display system of claim 10, wherein the indicator is a physical pointer.

16. The interactive computer display system of claim 10, wherein the indicator is a fingertip.

17. The method of operation of an interactive computer display system comprising:
designating a plurality of reference points on a computer display;
measuring a position of each of a plurality of reference points as depicted in one or more images of the computer display as captured by a monitoring device;
determining a distance between one or more pairs of the plurality of reference points, as depicted in one or more images of the computer display as captured by the monitoring device;
storing the position of each of the plurality of reference points in memory;
storing the position of each of the plurality of reference points, as measured on the computer display, in memory;
storing the distances between the one or more pairs of the plurality of reference points, as depicted in one or more images of the computer display as captured by the monitoring device, in memory.

18. The method of claim 17, wherein the plurality of reference points as depicted in one or more images of the computer display, as captured by the monitoring device, are located at or near the corners of the display as depicted in one or more images of the computer display as captured by the monitoring device; and
the distances between the one or more pairs of the plurality of reference points, as depicted in one or more images of the computer display as captured by the monitoring device, are the lengths of the sides of the computer display as captured by the monitoring device.

19. The method of claim 18, further comprising:
determining the location of an indicated point as depicted in one or more images of the computer display as captured by a monitoring device;
calculating the position of the indicated point on the computer display by determining its relative position to the plurality of reference points.

20. The method of claim 19, wherein the relative position of the indicated point on the computer display to the plurality of reference points is measured in terms of a percentage of the distances between the one or more pairs of the plurality of reference points.

21. The method of claim 20, wherein the indicated point is designated by a point of light projected on to the display by a light emitting device.

22. The method of claim 21, wherein the light emitting device is a laser.

23. The method of claim 21, wherein the light emitting device is a flashlight.

24. The method of claim 20, wherein the indicated point is indicated by a physical pointer.

25. The method of claim 20, wherein the indicated point is indicated by a fingertip.
